(19) United States
(12) Patent Application Publication
(10) Pub. No.: US 2004/0186708 A1
(43) Pub. Date: Sep. 23, 2004

(54) Device and method for controlling electronic output signals as a function of received audible tones

(76) Inventor: Bradley C. Stewart, Austin, TX (US)

Correspondence Address: LAMORTE & ASSOCIATES P.C., P.O. BOX 434, YARDLEY, PA, 19067, US

(21) Appl. No.: 10/793,029

(22) Filed: Mar. 4, 2004

Related U.S. Application Data
(60) Provisional application No. 60/451,813, filed on Mar. 4, 2003.

(51) Int. Cl. G10L 11/04

(52) U.S. Cl. 704/207

(57) ABSTRACT

A system and method that converts sound energy into electronic control signals. The control signals can be used either to control a secondary object, or to control a display in the playing of a game. A player first creates an audible note or sequence of notes by humming or singing. The system analyzes the audible notes by determining the primary pitch of each of the notes. The primary pitch is then electronically compared to the pitch of other standardized notes. The standardized notes may be the notes of a song or the primary notes in an octave. If the sung notes match the predetermined notes, a first control signal is created that can be use to activate a light or drive a motor. If the sung notes do not match the predetermined notes, secondary control signals are produced that depend upon the degree of derivation between notes.

### RELATED APPLICATIONS

This application claims priority of Provisional Patent Application No. 60/451,813, entitled Singing Toy And Game, which was filed on Mar. 04, 2003.

### BACKGROUND OF THE INVENTION

1. Field Of The Invention

The present invention relates to electronic control systems that can detect and process the tones of audible sounds. More particularly, the present invention relates to electronic control systems that are selectively controlled by audible sound signals.

2. Description Of The Related Art

The prior art is replete with toys and other novelty devices that are in some manner controlled by sound energy. One of the more popular of such toys is the dancing figure that dances whenever music is played or the ambient level of noise otherwise surpasses a predetermined level. An example for the control mechanisms for such prior art dancing toys is found in U.S. Pat. No. 4,903,424 to Satoh, entitled Movable Decoration. In a variation of this device, toys also exist that activate lights instead of dancing when sound energy is detected. Such systems are exemplified by U.S. Pat. No. 5,402,702 to Hata, entitled Trigger Circuit Unit For Operating Light Emitting Members Such As LEDs Or Motors For Use In Personal Ornament Or Toy In Synchronization With Music.

The circuitry needed to turn a device on or off with noise energy is rather simple. More difficulties occur when circuits are designed to differentiate one type of noise from another. It is particularly difficult to design circuitry that can detect derivations in a person's voice as a person speaks. Although voice recognition systems have been developed for personal computers, such systems utilize very sophisticated software. As such, voice recognition systems require large amounts of processing power to run the software and large memory caches to store the software. Furthermore, the person speaking must speak directly into a microphone and the software may take weeks of trial and error before the software runs properly.

It will therefore be understood that the state of the art in voice recognition software is not well suited for use in the design of toys and other novelty devices. This is due to the fact that such toys would be prohibitively expensive if they contained the processing power needed to run such voice recognition software and they would have operating systems that are too complex for a child to utilize properly.

Recognizing that the technology does not yet exist that makes it practical to place voice recognition systems in a low-cost novelty product, some control systems have been developed that are controlled by limited characteristics of sound energy, such as volume. For example in U.S. Pat. No. 5,407,376 to Avital, entitled Voice-Responsive Doll Eye Mechanism, and U.S. Pat. No. 3,795,064 to Sims-Williams, entitled Therapeutic Toy, toy control mechanisms are shown that detect the volume of sound energy. The louder the volume of sound that is detected, the faster the toy moves. Of course, such toy control systems are limited in that they cannot distinguish between ambient noise and the sounds made by the child trying to control the toy.

A need therefore exists in the art for an improved control system that uses sound energy that is low cost, does not require complicated software, yet detects specific features about a user's voice that can be converted into control signals. This need is met by the present invention as described and claimed below.

### SUMMARY OF THE INVENTION

The present invention is a system and method that converts sound energy into electronic control signals. The control signals are used either to control a secondary object, or to control a display in the playing of a game. To utilize the present invention system a player creates an audible note or sequence of notes by humming or singing. The present invention system analyzes the audible notes by determining the primary pitch of each of the notes. The primary pitch is then electronically compared to the pitch of other standardized notes. The standardized notes may be the notes of a song or the primary notes in an octave. If the sung notes match the predetermined notes, a first control signal is created that can be use to activate a light or drive a motor. If the sung notes do not match the predetermined notes, secondary control signals are produced that depend upon the degree of derivation between the sung notes and the predetermined notes.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of one exemplary embodiment of the present invention system;

FIG. 2 is a schematic of the system shown in FIG. 1;

FIG. 3 is a block diagram showing a first method of operation;

FIG. 4 is a block diagram showing a second method of operation;

FIG. 5 is a schematic of an alternate embodiment of the present invention; and

FIG. 6 is a block diagram showing a third method of operation.

### DETAILED DESCRIPTION OF THE DRAWINGS

The present invention system can be used to control many types of secondary devices. However, the present invention system can also, by itself, be embodied as a novelty device. Both applications of the invention are illustrated and described in order to set forth the best modes contemplated for the invention.

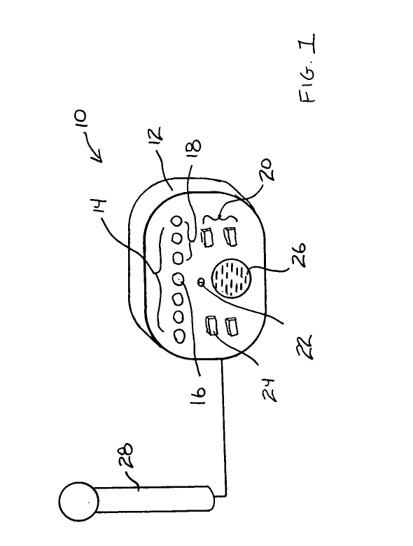

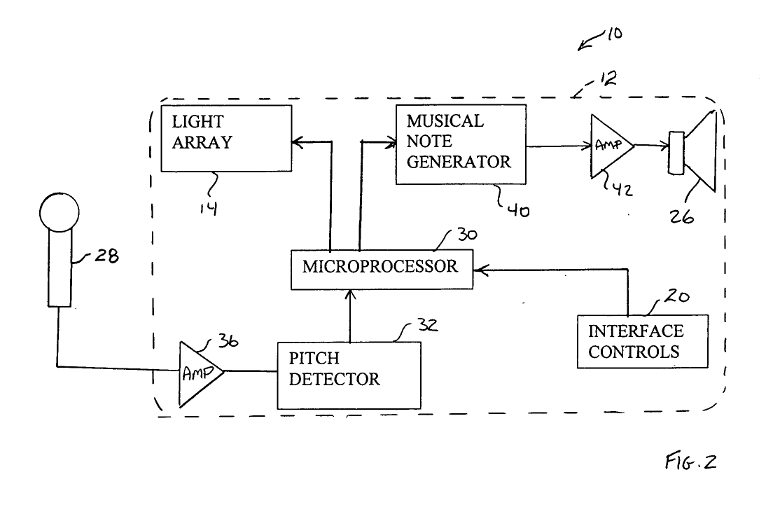

Referring to FIG. 1 in conjunction with FIG. 2, there is shown an exemplary embodiment of the present invention system 10. The system 10 has a housing 12. On the housing 12 there is an array of lights 14. The lights 14 can be LEDs or translucent panels backlit by LEDs or incandescent bulbs. Preferably, each of the lights has a different color. Also, in the preferred embodiment, there are at least eight lights so the lights can represent the eight major notes in an octave.

In the shown embodiment, the array of lights 14 includes a center light 16. On either side of the center light are equal numbers of secondary lights 18. It is preferred that the center light 16 be a unique color that is different from the secondary lights 18. In this manner, when the center light 16 is lit, it is immediately visually noticeable. The secondary lights 18 can all be the same color or different colors. For example, the center light 16 can be a green light. The secondary lights 18 can be color coded with the secondary lights farthest from the center light 16 being red, the secondary lights closest to the center light 16 being yellow and the middle secondary lights being shades there between. In this manner, a person viewing the secondary lights 18 can immediately visualize which of the secondary lights are lit and how close that light is to the center light 16.

Interface controls 20 are also provided. The interface controls 20 include an on/off button 22 and the control buttons 24 used to adjust the system 10 and select through a variety of different games that can be offered. Some of the variables that can be adjusted manually using the interface controls 20 include volume and microphone sensitivity.

A speaker 26 is provided within the housing 12. The speaker 26 is used to transmit audible tones out of the housing 12. Lastly, a microphone 28 is provided to receive audible signals from the user of the system 10. In the shown embodiment, the microphone 28 is shown as a component separate from the housing 12. It will be understood that the microphone 28 can also be built as part of the system 10 and the housing 12 would have a microphone port in the housing 12 under which would be positioned the microphone 28.

Referring solely to FIG. 2, it can be seen that within the housing 12 is held a microprocessor 30. The microprocessor 30 is connected to a pitch detector 32. The pitch detector 32 can be a dedicated circuit. The pitch detector 32 can also be a series of algorithms that are run by the microprocessor 30. The pitch detector 32 receives signals from the microphone 28, that are amplified by a first amplifier 36. The amplified microphone signal is processed by the pitch detector 32, wherein the primary pitch of the signal being received by the microphone 28 is isolated. In the prior art, there exist circuits and algorithms that are used to isolate the primary pitch contained in an audible speech signal. Such prior art systems are disclosed in Pitch Determination Of Speech Signals: Algorithms And Devices, by Wolfgang Hess, published by Springer-Verlag, 1983. Such prior art pitch detector circuits can be adapted for use as part of the present invention system 10.

The pitch detector 32 filters the amplified microphone signal so that a pitch signal that corresponds to the primary pitch of the received sound energy is forwarded to the microprocessor 30. The microprocessor 30 receives and processes the pitch signal in a manner dependent upon the game that is being played. The microprocessor 30 then activates the array of lights 14 and the musical note generator 40 in a manner dependent upon the game being played. The lights in the array of lights 14 can be directly observed by the user of the system 10. The output signal of the musical note generator 40 passes through a second amplifier 42 and is converted back into an audible signal by the speaker 26.

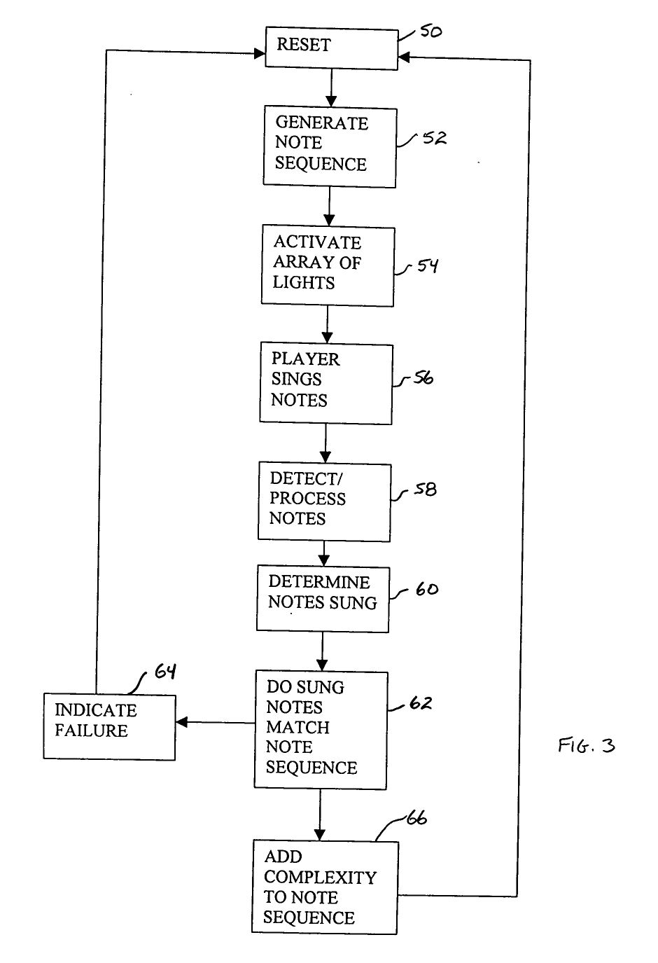

Referring now to FIG. 3 in conjunction with FIG. 2, an exemplary method of play for a game (FIG. 3) is shown that utilizes the system 10 of the present invention shown in FIG. 2. The game method of play is similar to Simon Says, in that a player is required to repeat the actions of the system 10. After each round of play, the difficultly level increases.

From Block 50 in FIG. 3, it can be seen that once a player selects the game about to be described, the system 10 is reset. The microprocessor 30 then selects a note or sequence of notes and causes the musical note generator 40 to play the selected note/notes via the speaker 26. See Block 52. Simultaneously, the microprocessor 30 also lights at least one light in the array of lights 14 that corresponds to the note/notes being played. See Block 54.

After the notes are played, a person is provided with a short length of time in which they can sing or hum the notes they just heard into the microphone 28. See Block 56. Once a player has sung or hummed the notes into the microphone 28, the pitch detector 32 processes the audible signal so that only the primary pitch of the audible signal is present. See Block 58. The output signal of the pitch detector 32 is then received by the microprocessor 30.

As is indicated by Block 60, the microprocessor 30 processes the signal from the pitch detector 32 and determines what notes were sung or hummed. Many people do not sing on key. Thus, if a flat note is detected, the microprocessor 30 assumes that the flat note is the closest proper octave note. Once the notes sung are determinable, the microprocessor 30 compares the notes that have been sung to the sequence of notes that were played by the musical note generator 40. See Block 62. If the sung or hummed notes do not match the played sequence of notes, a failure indicator is provided that can be visual and/or audible. See Block 64.

However, as is indicated by Block 66, if the notes sung or hummed by a player do match the note sequence played by the musical note generator 40, then the game continues. The complexity of the note sequence is then increased, by adding notes to the sequence and/or increasing the tempo of the sequence. The new, more complex note sequence is then played by the musical note generator 40 and the game cycle is replayed. The game cycles continue until either a player fails to match the played note sequence or until the note sequence reaches a predetermined maximum level of complexity.

The above described method of play can be modified in many ways. One such way is to have the sequence of notes played by the musical note generator 40 to be a commonly known song, such as “Happy Birthday”. Using the same method of play, a player would then sing the played song. The player can sing the song either after the song was played or while the song is being played. The system would then determine if the player did indeed sing the song well enough that they hit all the notes. If a player did sing the song properly, a more complex song, such as “The Star Spangled Banner” can be played and the game repeated. If the singer cannot hit all the notes of the song, the player does not advance. As such, the present invention system can be used as an electronic singing judge to determine if a singer has the ability to properly follow a tune.

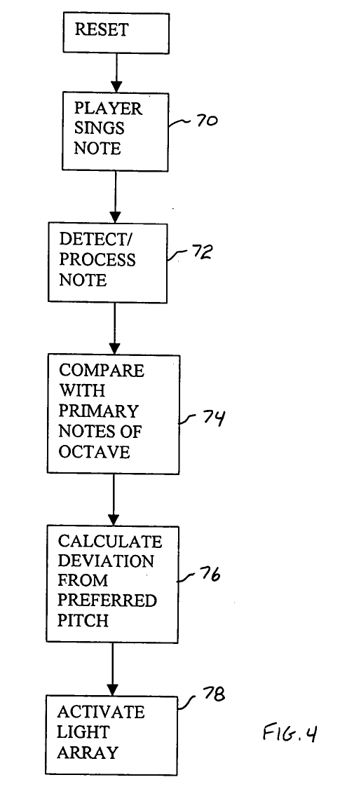

Using the same electronic layout of the present invention system that is shown in FIG. 2, alternate methods of play can also be enjoyed. One such alternate method of play is set forth in FIG. 4, Referring now to FIG. 4 in conjunction with FIG. 2, it can be explained that the present invention system 10 can be used as a voice trainer.

In this method of play, a player sings a note. See Block 70. The system 10 detects the note sung. The primary pitch of the note that was sung is determined by the pitch detector 32. Thus, the sung note is detected and processed as indicated by Block 72. That primary pitch is then sent to the microprocessor 30. The microprocessor 30 compares the primary pitch of the note that was sung to the primary notes of an octave. See Block 74. The microprocessor determines which note in the octave is closest to the sung note and determines the derivation in pitch from the sung note and the proper note. See Block 76.

Referring now to FIG. 1 in conjunction with FIG. 4, it will be understood that once the derivation between a sung note and a proper note is determined, the microprocessor lights one of the lights in the array of lights 14. See Block 78. If the sung note has the same pitch as a proper octave note, then the note was sung properly. The center light 16 in the array of lights 14 is then lit. If the sung note is sung flat, then one of the secondary lights 18 on one side of the center light 16 will be lit. The flatter the note is sung, the farther the light will be lit from the center light 16. Similarly, if the sung note is sung sharp, then one of the secondary lights 18 on the other side of the center light 16 will be lit. The sharper the note is sung, the farther the light will be lit from the center light 16. Thus, by looking at the array of lights 14 when a player is singing, a player can visualize whether or not they are singing on key. A singer can therefore change the pitch of the notes they sing to correct the error. By practicing singing and keeping the center light 16 of the array of lights 14 lit, a singer can be taught to sing on key.

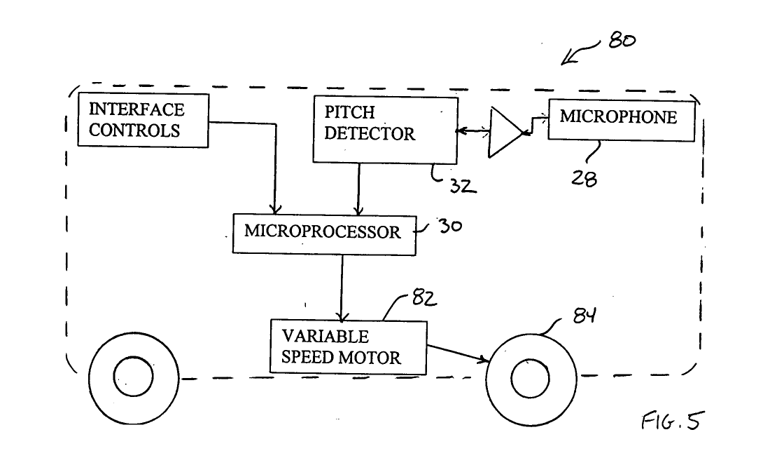

In the method of operation set forth in FIG. 4, the derivation between a note sung off key and a proper note is converted into light signals. It will therefore be understood that the present invention system provides a control system that is dependent upon the ability of a person to sing a note or a sequence of notes on key. Utilizing the present invention as a control system, the technology of the present invention system can be used to selectively control many different electronic devices other than just an array of lights. One such application for the present invention is set forth in FIG. 5.

Referring now to FIG. 5 there is shown a schematic for a toy vehicle 80. The toy vehicle 80 shares many of the same components as earlier embodiments. Accordingly, like parts are identified with the same reference numbers to avoid confusion. The toy vehicle 80 has a variable speed motor 82 that is attached to the drive wheels 84 of the vehicle 80. The variable speed motor 82 is controlled by the microprocessor 30. As with earlier embodiments, the microprocessor 30 is coupled to a pitch detector 32. The pitch detector 32 receives signals from a microphone 28 that is embodied within the toy vehicle 80.

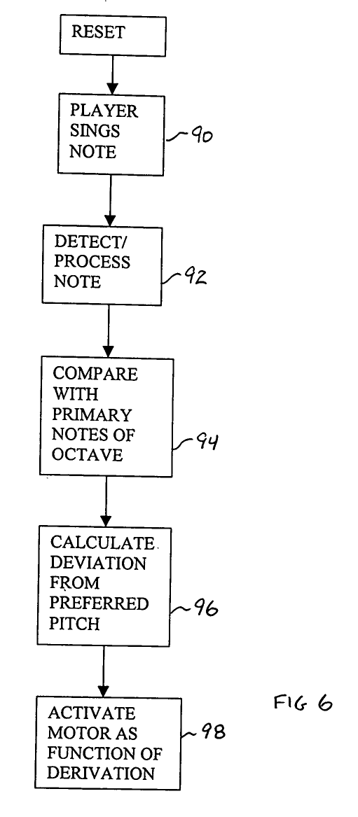

Referring to FIG. 6 in conjunction with FIG. 5, it will be understood that to operate the toy vehicle 80, a player must sing a note of a sequence of notes. See Block 90. The sung note is picked up by the microphone 28 in the vehicle 80. The primary pitch of the sung note is determined by the pitch detector circuit. See Block 92. The primary pitch of the sung note is then compared with the primary notes of an octave. See Block 94. The microprocessor 30 within the toy vehicle 80 calculates the tone derivation between the sung note and a proper pitch note. See Block 96. The closer the player comes to matching the sung note with the proper pitch, the faster the microprocessor 30 will drive the variable speed motor 82 and the faster the vehicle 80 will travel.

In the method of FIG. 6, a player randomly sings a note or sequence of notes. It should also be understood, that in a modification of this method, a musical note generator can be added to the toy vehicle. The musical note generator plays notes. A player would then have to match the notes played in order to activate the vehicle. The closer the player comes to matching the played notes, the further and faster the vehicle can travel.

It will be understood that the embodiment of the present invention in a toy vehicle as a control system is merely an exemplary application. The present invention system can be used to drive most any motor or any array of lights that are present in most any product. Thus, the present invention can be used on toy vehicles, model trains, dancing figures, moving dolls or any other product. The activation of any lights and/or motors within such products can be selectively controlled by the present invention system by having a user either sing notes or repeat notes audibly broadcast to the player.

All of the embodiments of the present invention system that are illustrated and described can be varied in many ways by a person skilled in the art. For example, the housing of the system shown in FIG. 1 and the placement of the components on that housing can be altered to the whims of the manufacturer. Furthermore, circuitry or programming can be added that would allow the sensitivity of the present invention system to be selectively varied. In this manner, players with no musical ability can adjust the system to have as much fun as those who sing perfectly in tune. All such alterations, modifications and alternate embodiments are intended to be included within the scope of the present invention as claimed.

What is claimed is:

1. A method for controlling an electronic device as a function of received audible notes, said method comprising the steps of:
receiving an audible note created by a person;
determining a primary pitch for said audible note;
comparing said primary pitch to a proper note pitch, therein determining a degree of derivation between said primary pitch and said proper note pitch;
creating control signals that correlate to said degree of derivation; and
operating an electronic device with said control signals.

2. The method according to claim 1, wherein said electronic device includes an array of lights.

3. The method according to claim 2, wherein said array of lights includes a primary light and secondary lights.

4. The method according to claim 3, wherein said step of operating an electronic device includes lighting said primary light when said primary pitch matches said proper note pitch.

5. The method according to claim 4, wherein said secondary lights are arranged at different distances from said primary light and said step of operating an electronic device includes lighting said secondary lights at different distances in proportion to said degree of derivation.

6. The method according to claim 1, wherein said electronic device is selected from a group consisting of lights and motors.

7. The method according to claim 1, further including the step of generating a tone of said proper note pitch, wherein the person attempts to reproduce said tone, therein creating said audible note.

8. A method comprising the steps of:
i. generating an original sequence of notes having at least one note and a predetermined level of complexity;
ii. having a person attempt to orally reproduce said original sequence of notes with a subsequent sequence of notes;
iii. electronically comparing said subsequent sequence of notes with said original sequence of notes to determine a match; and
iv. advancing said predetermined level of complexity if said subsequent sequence of notes matches said original sequence of notes.

9. The method according to claim 8 further including the step of repeating steps i through iv until said subsequent sequence of notes does not match said original sequence of notes.

10. The method according to claim 8, further including the step of determining a primary pitch for each of said sequence of notes.

11. The method according to claim 10, wherein said step of electronically comparing said subsequent sequence of notes with said original sequence of notes includes comparing said primary pitch for each of said sequence of notes with pitches associated with said original sequence of notes.

12. The method according to claim 8, further including an array of lights and selectively lighting different lights in said array of lights.

13. A system comprising:
a microphone for detecting notes;
a pitch detector circuit coupled to said microphone for determining a primary pitch associated with each of said notes detected;
a microprocessor coupled to said pitch detector circuit for comparing each said primary pitch to the eight notes in an octave to determine if each said primary pitch matches an octave note and to determine a degree of derivation if there is no match.

14. The system according to claim 13, further including a display that is coupled to said microprocessor that indicates said degree of derivation.

15. The system according to claim 14, wherein said display is an array of lights.

16. The system according to claim 13, further including a musical note generator for generating octave notes audibly.

17. The system according to claim 13, further including a motor coupled to said microprocessor, wherein said microprocessor operates said motor as a function of said degree of derivation.
